(19) United States
(12) Patent Application Publication
(10) Pub. No.: US 2018/0028852 A1
(43) Pub. Date: Feb. 1, 2018

(54) TRAINING APPARATUS

(71) Applicant: Beaverfit Limited, Church Stretton Shropshire (GB)

(72) Inventors: Thomas Edward Beaver, Church Stretton Shropshire (GB); Richard James Beaver, Church Stretton Shropshire (GB)

(73) Assignee: Beaverfit Limited, Church Stretton Shropshire (GB)

(21) Appl. No.: 15/541,946

(22) PCT Filed: Jan. 6, 2016
(86) PCT No.: PCT/EP2016/050139

§ 371 Date: Jul. 6, 2017

(30) Foreign Application Priority Data
Jan. 6, 2015 (GB) 1500110.0
Mar. 4, 2015 (GB) 1503674.2

(51) Int. Cl. A63B 17/00; A63B 9/00; A63B 21/16; A63B 71/00; A62C 99/00; A63B 21/04

(52) U.S. Cl. CPC A63B 17/00; A62C 99/0081; A63B 21/04; A63B 21/16; A63B 71/0036; A63B 9/00; A63B 21/078

(57) ABSTRACT

A training apparatus 1 comprising a structure 3 and exercise equipment 5, wherein the structure 3 includes a first side wall 7, a second side wall 9 and a partition 11; the partition 11 extends between the first side wall 7 and the second side wall 9 and comprises a breaching door 17; and the exercise equipment 5 is fixed to an external surface of the structure 3.

The invention relates to a training apparatus.

It is known that certain methods of training personnel require the personnel to practice method of entry by first breaching a breaching door. Such training methods are commonly used in the military and uniformed services, such as the fire service and the police. These methods typically require facilities, such as buildings, that are required to be purpose built, or substantially converted, to be suitable for use in such methods, e.g. by being fitted with breaching doors.

Viewed from a first aspect, the invention provides a training apparatus comprising a structure and exercise equipment, wherein: the structure includes a first side wall, a second side wall and a partition; the partition extends between the first side wall and the second side wall and comprises a breaching door; and the exercise equipment is mounted to an external surface of the structure.

Viewed from a second aspect, the invention provides a training apparatus comprising exercise equipment, the exercise equipment comprising a framework, and the training apparatus comprising a breaching door mounted in a door frame of the framework.

Thus, the training apparatus provides an integrated solution for both practicing door breaching and for fitness work. This allows the users of the apparatus to practice door breaching, and then physically exert themselves on the exercise equipment, before returning to practice door breaching whilst using only the training apparatus of the present invention.

The inventors have found that mixing the breaching practice aspect with physical exercise improves the quality of the training. It is very useful for personnel to practice breaching whilst being physically tired as it replicates an operational situation. The present invention provides a simple integrated solution that allows the user to cycle between practicing method of entry and physical exercise. This cyclical training is advantageous as it allows the user to rehearse door breaching whilst becoming progressively more fatigued, which is particularly advantageous in training the personnel.

The integrated nature of the present invention allows for a simple unitised training apparatus, and for improved training results.

Breaching doors are known in the art of rehearsing door breaching. Breaching doors are doors that are specifically designed to be breachable and re-useable. The doors are typically breachable through force exerted by the user, e.g. by using a ram, explosives, a shotgun, etc. Breaching doors typically have a strong frame that is substantially undamaged when the door is breached, and are held closed by replaceable sacrificial elements that are intentionally broken when the door is breached. To reset the breaching door, the sacrificial element typically must be replaced by a new sacrificial element. Examples of such doors are those produced by Breaching Technologies Inc., BCM Inc. and Sweden Entry Tools.

Thus, it should be noted that “breaching door” is a term known in the art, and is distinguished from merely a standard door. A standard door may be breachable, but is typically damaged when breached in such a way that it cannot be closed/locked such that it can be breached again without substantial repair.

The breaching door of the training apparatus may therefore have a breakable sacrificial element. The breaching door is configured to allow replacement of the sacrificial element after it has been broken.

The exercise equipment is equipment suitable for fitness work. It may comprise at least one of monkey bars, pull-up bars, squat racks, climbing ropes, climbing nets, climbing ladders, climbing walls etc. Preferably, the exercise equipment comprises functional training equipment.

The first side wall, the second side wall and/or the partition may be substantially vertical. The first side wall and the second side wall may extend substantially parallel to one another. The first side wall and the second side wall may have substantially the same heights. The first side wall, the second side wall and the partition may have substantially the same heights. The partition may extend substantially perpendicularly to the inner surface of the first and/or second side walls. The partition may physically contact the inner surface of the first and/or second side walls. The partition may be fixed to the inner surface of the first and/or second sidewalls.

The partition may comprise at least one panel and the breaching door. The partition may comprise a wall portion and the breaching door. The partition may be supported by at least one beam. The partition may be held in position, or restrained, by the beam. The beam may connect to the upper edge of the partition. The beam may connect to the lower edge of the partition. The beam may be horizontal. The beam may be fixed to a roof and/or a floor of the structure (see below). The beam may extend from the first side wall to the second side wall. The frame of the breaching door may be connected to the beam. This beam provides strengthening to the training apparatus.

The partition may be an internal partition. Alternatively, the partition may be an external partition, such as a third side wall of the structure. The partition may be located at an outer end of the structure.

It should be noted that the end of the structure is not the same as the sides. The end is located at a lateral extremity of the structure taken in the direction in which the sides extend.

The exercise equipment may be removably mounted to the structure, for example by using bolts. The exercise equipment may be permanently fixed to the structure, for example by being welded.

The structure may be positionable on a ground surface and at least some of the exercise equipment may be configured to be engageable with the ground surface. Thus, the exercise equipment may help to stabilise the structure. The exercise equipment may comprise horizontal components projecting outward horizontally from the structure. The horizontal components may be connected to respective vertical components which are adapted to be engageable with the ground. There may be a bar horizontally interconnecting adjacent connected respective horizontal and vertical components.

The exercise equipment may comprise a plurality of cantilever components, each cantilever component being supported by a respective vertical component, and a plurality of horizontal bars interconnected between adjacent cantilever components.

At least some of the exercise equipment may be fixed to the first side wall and/or the second side wall. This may further aid the stabilisation of the training apparatus.

At least some of the exercise equipment may be located adjacent to the external surface of the first side wall and at least some of the exercise equipment may be located adjacent to the external surface of the second side wall. This allows exercise equipment to be located on opposite sides of the structure and hence effectively surround the structure with the partition therein. This allows the present unitised solution to provide more exercise equipment in the immediate vicinity of the breaching door. This can lead to greater number of simultaneous users or greater variety in the form of the exercise equipment.

The training apparatus may further comprise buttresses extending from the training apparatus to the ground. The buttresses may extend from the structure. The buttresses may extend from the exercise equipment. The buttresses may extend from the vertical components of the exercise equipment.

The structure may be a transportable structure, such as a transportable cabin. The transportable structure may be loadable onto a trailer of a lorry for example. The structure may be a prefabricated structure. The prefabricated structure may be cheap and readily available, and may simplify construction and deployment of the training apparatus. This is particularly advantageous over the typical facilities already used in such training where purpose built, or converted, buildings are used. Such buildings are much more expensive, are of a more permanent nature and are, of course, not transportable. For example, the present invention could be quite straightforwardly temporarily placed and erected in a training ground, e.g. in a military base. The present invention could subsequently be easily moved to any appropriate location it was needed, e.g. a different training ground at a different military base.

For example, in a particularly advantageous embodiment, the structure may be an ISO shipping container. The ISO shipping container may be a 3 m, 6.1 m or 12.2 m ISO shipping container.

The first side wall and/or the second side wall may comprise a shooting wall, which may be in the form of a reinforced portion. The reinforced portion provides additional strength to the side wall, which may be desirable for certain uses of the training apparatus. For instance, when used by training soldiers or police officers, it is possible that firearms will be used in the vicinity of the training apparatus. Such a reinforced portion may prevent bullets, for example, from passing through the wall or from ricocheting off the wall.

In a particularly advantageous embodiment, the reinforced portion may comprise a ballistic wall, such as a ballistic paneled wall.

Alternatively, instead of a reinforced portion, a wooden portion may be used. The wood may preferably be plywood panels. The wooden portion acts as a sacrificial portion that allows bullets etc. to pass through it. This reduces the risk of ricochets when fire arms are used within the breaching lock.

At least one of the first side wall and the second side wall comprises at least one breaching window. Alternatively/additionally, the breaching window may be located in the partition.

A breaching window, similar to a breaching door, is a well known term in the art of method of entry and has a specific meaning. Breaching windows are windows that are specifically designed to be breachable and re-useable by the user. The windows are typically breachable through force exerted by the user, e.g. by using a ram or a break and rake tool, explosives, a shotgun, etc. Breaching windows typically have a strong frame that is substantially undamaged when the window is breached. The breaching window also comprises sacrificial elements, such as glass panes, that are intentionally broken when the window is breached. To reset the breaching window, the sacrificial element typically must be replaced by a new sacrificial element. Examples of such windows are those produced by Breaching Technologies Inc. and Sweden Entry Tools.

Thus, it should be noted that “breaching window” is a term known in the art, and is distinguished from merely a standard window. A standard window may be breachable, but is typically damaged when breached in such a way that it cannot be reset such that it can be breached again without substantial repair.

The breaching window of the training apparatus may therefore have a breakable sacrificial element. The breaching window is configured to allow replacement of the sacrificial element after it has been broken.

The inclusion of the breaching window allows for additional functionality of the training apparatus.

The breaching window may be provided in the shooting wall, reinforced portion and/or wooden portion. The strength of the reinforced portion is advantageous to support the breaching window, especially during breaching—the surround wall is not damaged. This may also ease manufacture of the training apparatus. The reinforced portion or wooden portion may simply replace a portion of the wall of the structure. The reinforced portion or wooden portion may thus already have the breaching window incorporated with it, or at least have a hole suitable for the attachment of the breaching window, prior to attachment to the remainder of the structure. The reinforced portion or wooden portion may be pre-fabricated. The reinforced portion or wooden portion may consist of one piece of material.

Alternatively, the breaching window may simply be provided in a wall of the structure, e.g. the ISO container, preferably an external wall.

At least one of the first side wall and the second side wall may comprise at least one side breaching door. The side breaching door may be the breaching door discussed above, or may be in addition to the breaching door discussed above. The side breaching door(s) may be provided in the reinforced portion(s) or wooden portion(s). Alternatively, the side breaching door(s) may simply be provided in a wall of the structure, e.g. the ISO container, preferably an external wall.

At least one of the first side wall and the second wall may comprise at least one aperture. Again, this adds broadened functionality to the apparatus. When being used for training personnel with firearms, such apertures through the walls may provide to allow for line of sight between the interior and the exterior of the structure. The apertures may be positioned at various heights.

The aperture may be provided in the shooting wall, reinforced portion or wooden portion. Again, this is particularly advantageous when the apparatus is to be used for training personnel tactically using firearms. However, it also eases manufacture as stated above in relation to the breaching window. It is advantageous to have the aperture in the wooden portion because as the aperture (of any desire shape) can easily be cut into the wooden portion.

The structure may comprise a roof extending between the first side wall and the second side wall and the partition may extend to the roof. The roof may therefore form a closed interior of the structure. The roof may provide a further platform for the user to perform exercises outside of the structure. The partition may also form a closed partition up to the roof, effectively blocking one end of the structure from the other.

At least some of the exercise equipment is located at a height above the roof. This allows for greater flexibility in the exercises performed, and encourages the use of the roof itself as a platform for some exercises.

At least some of the exercise equipment is fixed to the roof. This helps to maximise the external surface of the structure used. All of the exercise equipment may be fixed to the roof, i.e. there may be no exercise equipment fixed to the walls of the structure.

The roof may be strengthened such that it is capable of supporting the weight of one or more adult person(s) training thereon. The roof may be strengthened to take an additional weight of 100 kg, 200 kg, 500 kg or 1000 kg. The roof may therefore be used as a training platform. The external surface of the roof may comprise a non-slip coating.

The roof may comprise a balustrade. This can improve the safety of the personnel using the roof as a training space. The balustrade may comprise one or more gates to allow a user to enter and exit the roof, e.g. via ropes, netting or ladders. The balustrade may be provided around the perimeter of the roof. At least a portion of the balustrade may extend vertically upward from the side walls.

The roof may also comprise one or more reinforced panels (such as ballistic panels) and/or wooden panels (such as plywood panels) with apertures therein. These panels may be attached to and supported by the balustrade.

The roof may comprise a roof hatch. This allows access from inside to outside of the structure, which may be particularly useful to increase the physical demand on the user of the training apparatus.

The roof hatch may comprise a hole in the roof. The edges of the hole may be supported by a frame. The frame may be substantially the same shape as the hole. The hole may be rectangular. The frame may comprise a plurality of interconnecting strengthening beams. The beams may be steel beams. The frame may be connected to the partition. The frame may be connected to a frame of the breaching door. Such connections may be made directly, or by additional beams, such as steel beams. This acts to strengthen the training apparatus. The frame may be connected to the lower surface of the roof (i.e. the interior surface of the roof). The hatch may comprise a panel that connects to the structure, e.g. the roof or the frame. The panel may be connected via a hinge, or may be removable.

There may be a climbing rope and/or a ladder provided to allow user to climb out of the roof hatch.

There may be a plurality of roof hatches.

The structure may comprise a floor extending between the first side wall and the second wall and the partition extends to the floor. The floor may therefore form a closed interior of the structure. The partition may also form a closed partition down to the floor, effectively blocking one end of the structure from the other. The floor may be sufficiently strong to support the weight of all the internal components of the training apparatus, and several users.

The floor may comprise a floor hatch. This allows access from inside to outside of the structure, which may be particularly useful to increase the physical demand on the user of the training apparatus. The floor hatch may be directly, i.e. vertically, below the roof hatch. Thus, if two such structures are stacked together (see below) the floor hatch of the upper structure and the roof hatch of the lower structure form a passage between the interiors of the two structures. The floor hatch may have substantially similar dimensions to the roof hatch.

The floor hatch may comprise a hole in the floor. The edges of the hole may be supported by a frame. The frame may be substantially the same shape as the hole. The hole may be rectangular. The frame may comprise a plurality of interconnecting strengthening beams. The beams may be steel beams. The frame may be connected to the lower surface of the floor (i.e. the external surface of the floor). The hatch may comprise a panel that connects to the floor or frame. The panel may be connected via a hinge, or may be removable. There may be more than one floor hatch.

In a particularly advantageous embodiment, the partition may be a first partition and the breaching door may be a first breaching door, and the structure may further comprise a second partition, the second partition extending between the first side wall and the second side wall. The second wall may comprise a second breaching door. Thus, the training apparatus may effectively have a closed space within the structure that is defined by the first and second partitions and the two side walls. Breaching such a closed spaced is particularly advantageous and desirable in many training regimes in order to create task related realism.

The second partition and/or second breaching door may comprise any of the features discussed above for the first partition. For instance, the roof hatch frame may connect to the second partition/second breaching door frame, the second partition may extend to the roof, the second partition may extend to the floor, etc.

Advantageously, the structure may comprise an internal cage. The internal cage may support the side walls, the roof, the floor, the shooting wall, the reinforced portion, the wooden portion, the partition(s) and/or the breaching door. This internal cage may be formed of beams spanning between the side walls and between the partition(s). The beams spanning between the side walls may be the horizontal beams of each partition. The beams spanning between partitions may be the additional beam of the roof hatch and the roof hatch frame discussed above. The frame of each breaching door may also be fixed to the horizontal beam and connected to the floor thus forming part of the cage structure.

The shooting wall(s), the reinforced portion(s), the wooden portion(s), the breaching window(s), the aperture(s), the side breaching door(s), the roof hatch(es) and/or the floor hatch(es) may be located between the first partition and the second partition. Thus, these features may be provided within the closed space, which again is particularly advantageous for certain training regimes. Additional shooting wall(s), reinforced portion(s), wooden portion(s), breaching window(s), the side breaching door(s) aperture(s), roof hatch(es) and/or floor hatch(es) may be provided at a location outside (i.e. not between) the first and second partitions.

A training apparatus may comprise the training apparatus as described above and a second structure, wherein: the second structure includes a first side wall, a second side wall and a partition, the partition extending between the first side wall and the second side wall and comprising a breaching door; and the second structure is located on top of and is fixed to the training apparatus as described above.

A training apparatus may comprise the training apparatus as described above and a second structure, wherein: the second structure includes a first side wall, a second side wall and a partition, the partition extending between the first side wall and the second side wall and comprising a breaching door; and the training apparatus as described above is located on top of and is fixed to the second structure.

These embodiments allow for two similar structures to be stacked on top of one another. It should be noted that any of the limitations discussed above in relation the structure of the training apparatus are applicable to the second structure of these embodiments, e.g. the training apparatus, the hatches, the partitions, the apertures, the side breaching doors, the windows, the roof, the floor, etc.

Considering further the second aspect of the invention, the framework may comprise an outer frame having at least two upright members each extending vertically in the same general plane as the door frame with at least one upright member on each side of the door frame, and a cross member extending between the upright members above the breaching door. It is expected that in use the breaching door may be subjected to substantial forces, and so the frame for the breaching door needs to be able to withstand the resulting loading on multiple occasions. The outer frame can serve to provide a strong support for the door frame. The cross member of the outer frame may itself serve as the head of the door frame, or alternatively the head of the door frame may be provided as a separate member below the cross member and secured thereto.

The door frame may have a pair of upright jambs. Each jamb may be rigidly secured to a respective upright member of the outer frame. The upright members may each be in contact with a respective jamb, or they may each be laterally spaced from a respective jamb and rigidly secured thereto by a connecting member. The connecting member may for example also serve as a ground engaging plate of the framework. The connecting member may engage directly with the jamb, or it may engage with a sill of the door frame which then connects to the jamb.

In the arrangements discussed above, therefore, there is provided both a door frame for the breaching door, and an outer frame which supports the door frame. The framework thus provides a strong and rigid support for the breaching door, whilst also serving as the framework for the exercise equipment.

A set of rolling members, such as wheels, may be attached to the framework. These may be used to roll the framework along the ground. This may be desirable when a space is used for the training apparatus, but also needs to be used for other purposes.

The vertical position of each rolling member may be adjustable relative to the framework so as to be movable between a lower position allowing the rolling members to roll along the ground when the frame is to be moved, and a raised position allowing feet of the framework to engage the ground. When the rolling members are in the raised position and the feet engage the ground, the apparatus may be used for physical exercise and door breaching drills.

The weight of the apparatus may be sufficient to hold it stably during training activities, but optionally the feet of the framework may be secured to the ground, for example by bolting. Where the framework has rolling members, such securing will usually be on a temporary basis.

The framework may comprise at least two mutually perpendicular members, and a stiffening member may extend between respective portions of the at least two mutually perpendicular members at a non-perpendicular angle to both the members. Thus the framework can be made more rigid. This is expected to be particularly beneficial in the case of training apparatus which is to be rolled from one location to another.

Viewed from a third aspect, the invention provides a training apparatus comprising exercise equipment, the exercise equipment comprising a framework, and the framework comprising feet for engaging the ground, at least two mutually perpendicular members, a stiffening member extending between respective portions of the at least two mutually perpendicular members at a non-perpendicular angle to both the members, and a set of rolling members attached to the framework, the vertical position of each rolling member being adjustable relative to the framework so as to be movable between a lower position allowing the rolling members to roll along the ground when the framework is to be moved, and a raised position allowing the feet of the framework to engage the ground.

The stiffening member serves to make the framework more rigid, which is beneficial when the training apparatus is to be rolled from one location to another.

The at least two mutually perpendicular members and the stiffening member may be arranged in a generally horizontal plane. Improved rigidity in this plane is desirable when the apparatus is to be moved by rolling across the ground.

The training apparatus may comprise a plurality of plates all arranged in the same general vertical plane, for mounting the apparatus to a structure. The apparatus may be used in a permanent location adjacent to a structure, and the mounting plates may be used to secure the apparatus to such a structure, for example to a wall thereof. The structure may be a self-stabilizing transportable structure. The structure may be a prefabricated structure. The structure may be a fixed structure such as a building.

In one broad, fourth, aspect, the invention provides a training apparatus comprising exercise equipment and a breaching door. This allows personnel to practice door breaching whilst being physically tired, after having trained on the exercise equipment. The breaching door may be provided as part of a partition of a structure, or it may be mounted in a door frame of a framework which is part of the exercise equipment. The application of physical exercise and door breaching in one embodiment can be desirable, as it allows the performer to achieve training that is close to the operational reality.

Certain preferred embodiments of the invention will now be described, by way of example only, with reference to the accompanying drawings in which:

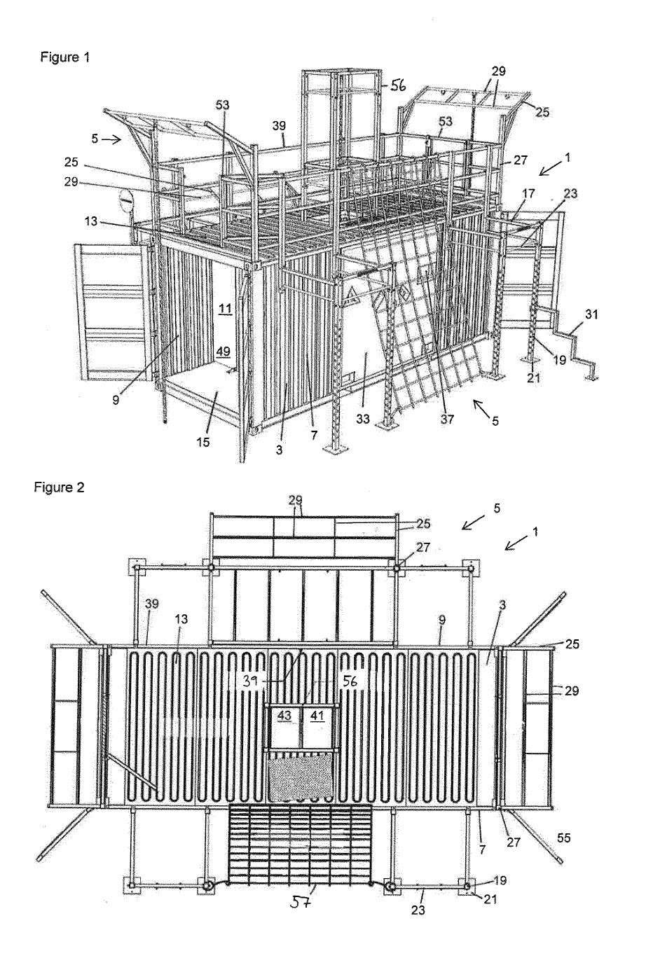

FIG. 1 shows a first perspective view of a first embodiment;

FIG. 2 shows a plan view of the embodiment;

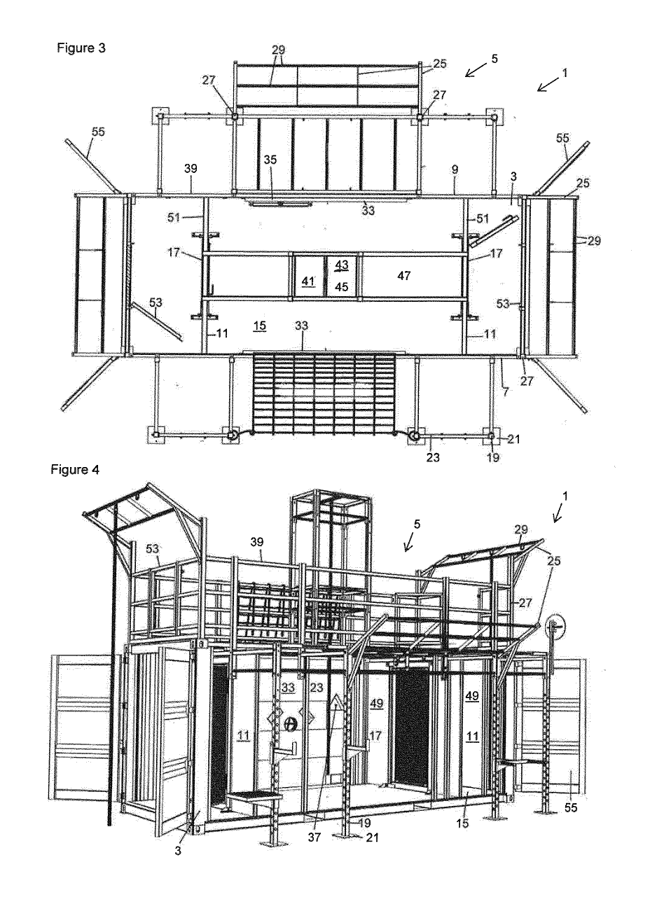

FIG. 3 shows a cut-away plan view of the embodiment;

FIG. 4 shows a cut-away perspective view of the embodiment;

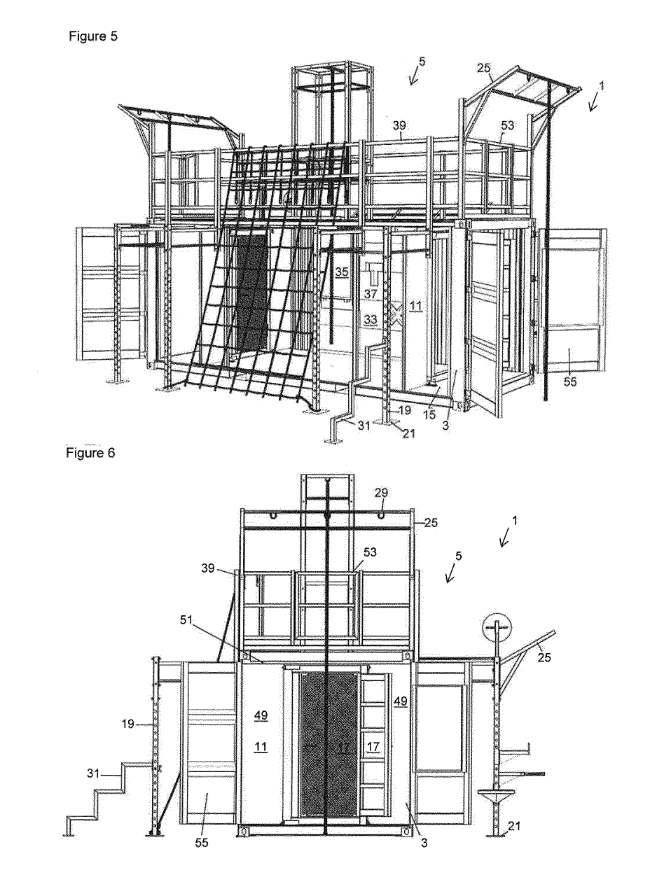

FIG. 5 shows another cut-away perspective view of the embodiment;

FIG. 6 shows a cut-away end view of the embodiment;

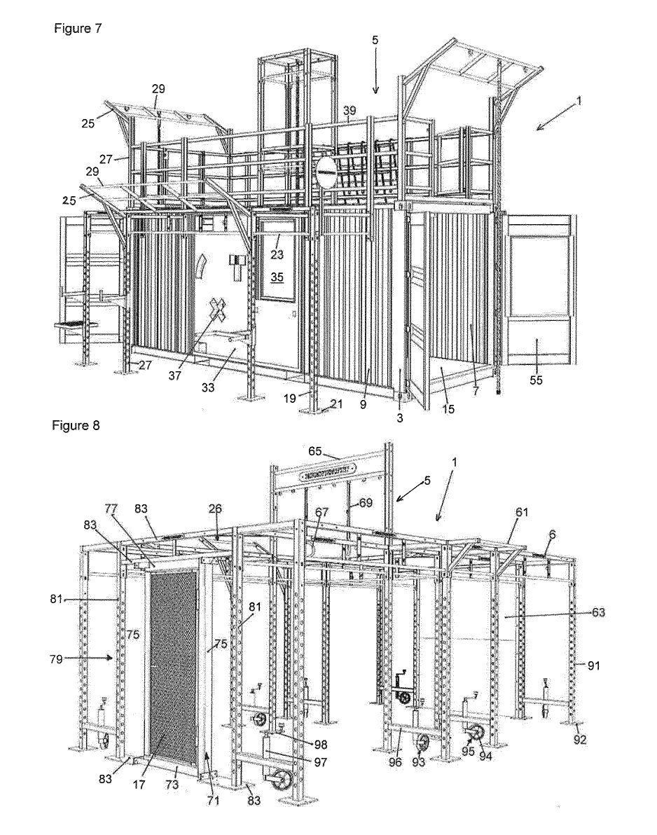

FIG. 7 shows another perspective view of the embodiment;

FIG. 8 shows a perspective view of a second embodiment;

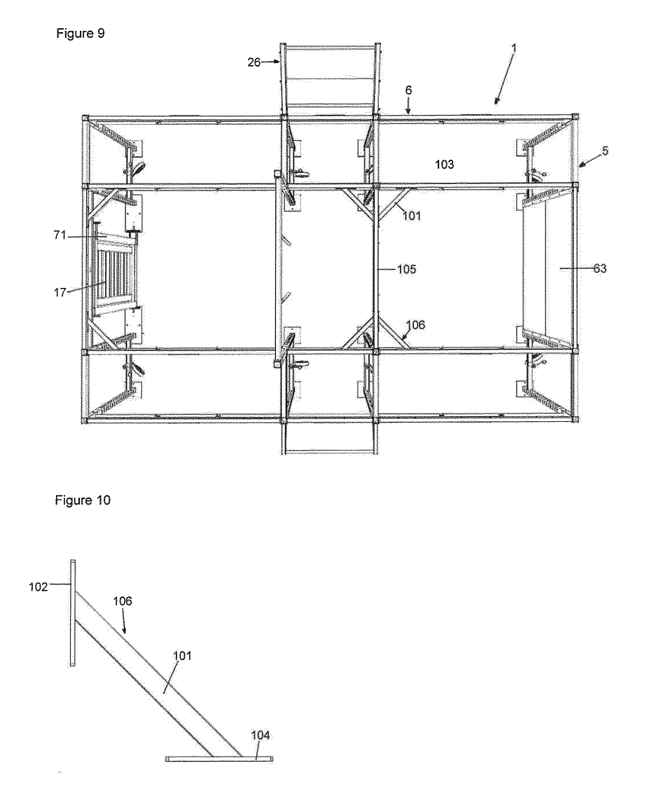

FIG. 9 shows a plan view of the second embodiment;

FIG. 10 shows a plan view of a bracket of the second embodiment;

FIG. 11 shows a perspective view of the bracket;

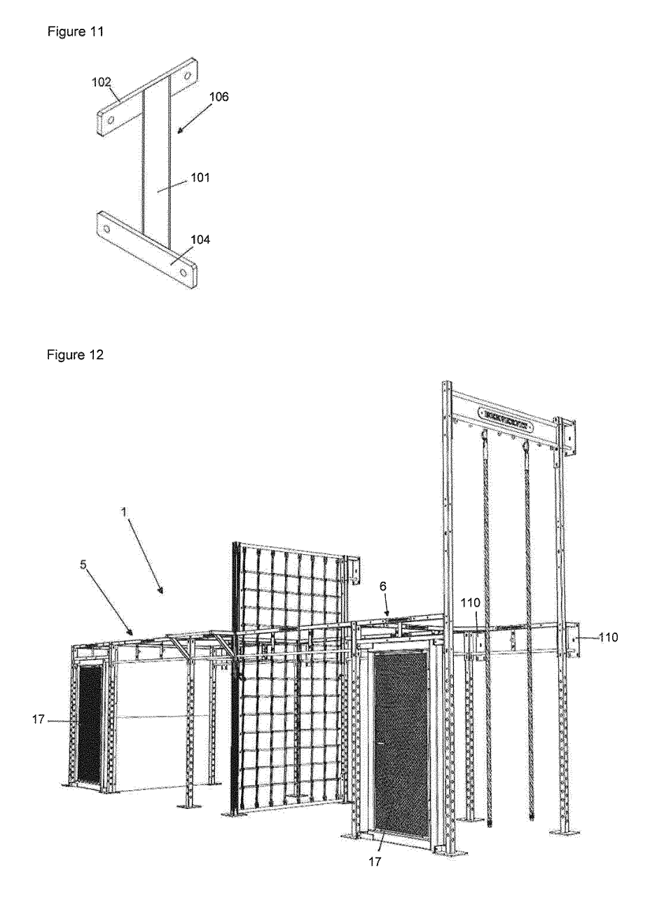

FIG. 12 shows a first perspective view of a third embodiment; and

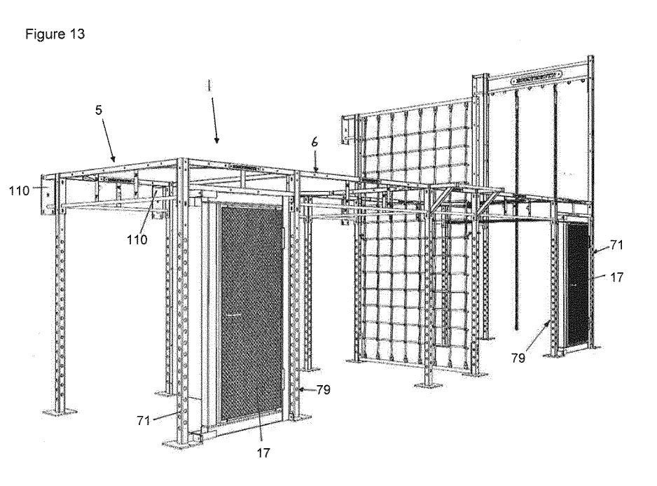

FIG. 13 shows a second perspective view of the third embodiment.

With reference to the Figures, a training apparatus 1 comprising a structure 3 and exercise equipment 5 is shown. The structure 3 includes a first side wall 7, a second side wall 9, two partitions 11, a roof 13 and a floor 15. Each partition 11 is an internal partition (i.e. not located at the ends of the structure 3) and extends between the first side wall 7, the second side wall 9, the roof 13 and the floor 15, such that the partition contacts each of these components and effectively blocks of one end of the structure 3 from the end. Each partition 11 comprises a breaching door 17. The exercise equipment 5 is mounted to an external surface of the structure 3.

Although in general the exercise equipment 5 present may vary, in this embodiment the exercise equipment comprises monkey bars, cantilevered wings, squat racks, climbing ropes, climbing rope towers climbing nets and climbing ladders.

The first side wall 7, the second side wall 9 and each partition 11 are vertically orientated. The first side wall 7 and the second side wall 9 extend parallel to one another. The first side wall 7 and the second sidewall 9 have equal heights. Each partition 11 extends perpendicularly to the inner surface of the first 7 and second 9 sidewalls. Each partition 11 is fixed to the inner surface of the first 7 and second 9 sidewalls, such that each partition 11 is in contact with the inner surfaces along its entire height.

In use, the structure 3 is positioned on a ground surface and at least some of the exercise equipment 5 is engaged with the ground surface. The exercise equipment 5 comprises horizontal components 16 projecting outward horizontally from the structure 5. The horizontal components 16 are connected to respective vertical components 19 which are engaged with the ground via ground-engaging plates 21. There is a bar 23 horizontally interconnecting adjacent connected respective horizontal 17 and vertical components 19.

The exercise equipment 5 comprises a plurality of cantilever components 25, each cantilever component 25 being supported by a respective vertical component 27, and a plurality of horizontal bars 29 interconnected between adjacent cantilever components 25.

At least some of the exercise equipment 5 is fixed to the first side wall 7 and the second side wall 9.

Thus, at least some of the exercise equipment 5 is located adjacent to the external surface of the first side wall 7 and at least some of the exercise equipment 5 is located adjacent to the external surface of the second side wall 9. This allows exercise equipment to be located on opposite sides of the structure and hence effectively surround the structure 3 with the partition 11 therein.

The training apparatus 1 further comprises buttresses 31 extending from the training apparatus 1 to the ground. The buttresses extend from the vertical components 19 of the exercise equipment 5.

The structure 3 used in the present embodiment is an ISO shipping container.

The first side wall 7 and the second side wall 9 each comprises a shooting wall, which may take the form of a reinforced portion 33. The reinforced portion 33 takes the form of a ballistic wall. The reinforced portion 33 is provided with a lining. Alternatively, the element 33 could be a plywood panel.

The reinforced portion 33 of the second side wall 9 comprises a breaching window 35. In the present embodiment, the reinforced portion 33 is a pre-fabricated element that replaces a corresponding section of the side walls 7, 9 of the structure 3.

The first side wall 7 and the second wall 9 comprise a plurality of apertures 37, the apertures 37 being positioned at various heights and locations in the side walls 7, 9. The apertures 37 are provided in the reinforced portion 33.

The partitions 11 may comprise panels 49 and the breaching door 17. The partitions 11 are at least partially supported by a beam 51 connecting to the upper edge of the partition. The beam 51 is horizontal and is fixed to the roof 13. The beam 51 extends from the first side wall to the second side wall. The frame of the breaching door 17 is connected to the beam 51.

The roof 13 is strengthened such that it is capable of supporting the weight of one or more adult person(s) training thereon. The external surface of the roof 13 comprises a non-slip coating. The roof 13 comprises a balustrade 39. The balustrade 39 comprises two gates 53. Each gate 53 is positioned at an opposite end of the structure 3. The balustrade 39 is provided around the perimeter of the roof 13 and extends vertically.

The roof 13 comprises a roof hatch 41. The roof hatch 41 comprises a rectangular hole 43 in the roof 13, the edges of the hole 43 being supported by a frame 45. The frame 45 is substantially the same shape as the hole 43. The frame 45 comprises a plurality of interconnecting strengthening steel beams. The frame 45 is connected to the partition 11 by additional beams 47 at the beam 51. The frame 45 and the beams 47 are connected to the lower surface of the roof 13.

The additional beams 47, the horizontal beams 51 and the frame of the breaching door 17 may form an internal cage that acts to structurally support the training apparatus 1.

There is a climbing rope provided to allow user to climb out of the roof hatch 41. The rope is suspended above the roof hatch 41 by means of rope tower 56. There is a climbing net 57 extending from the ground to the roof 13 of the structure.

In this particular embodiment, the structure 3 also comprises external doors 55 at each end of the structure 3.

The second embodiment is shown in FIGS. 8 to 11. A training apparatus 1 comprises exercise equipment 5. The exercise equipment comprises a framework 6 which supports various types of exercise equipment, including a cantilevered wing 25, a pull up bar 61, a climbing wall 63, a rope tower 65 with rings 67 suspended from ropes 69.

The training apparatus 1 of the second embodiment also comprises a breaching door 17 supported in a door frame 71. The door frame 71 provides a secure mount for the breaching door 17. It has a sill 73, two upright jambs 75 and a head 77.

The region of the training apparatus where the breaching door is provided will be subject to severe loading in use, in particular shock loading due to actions to breach the door, and hence requires sufficient strength. Therefore an outer frame 79 is provided.

The outer frame 79 has two upright members 81 each laterally spaced from the door frame in its general plane. Each upright member 81 rests on a respective ground engaging plate 83. The laterally inner ends of the ground engaging plates 83 provide support for the jambs 75 of the door frame and, via the jambs, for the door sill 73. A pair of vertically spaced lateral bars 83 is provided above the door frame. The upright members 81 are laterally interconnected by the lateral bars 83. At least the lower lateral bar 83 forms a cross member of the outer frame. The lower lateral bar 83 is connected to the head 77 of the door frame and provides support for it.

The framework 6 of the exercise equipment 5 comprises a plurality of upright members 91, each of which is provided at its lower end with a respective ground engaging plate 92. These plates may rest on the floor or ground without further attachment, or they may be attached to the floor or ground, for example by bolting.

The framework is provided with a set of wheels 93 which may be upwardly retracted to allow the ground engaging plates 92 to engage the ground or they may be lowered relative to the framework 6 in order to lift and allow it to be easily moved. Each of the wheels 94 of the set of wheels 93 is provided as part of a wheel unit 95. The uprights 91 are provided in a plurality of pairs, with a horizontal bar 96 extending between the two upright members 91 of a pair close to ground level but upwardly spaced therefrom. Each horizontal bar 96 is formed with a hole through which passes a tube 97 of a respective wheel unit 95. The tube 97 is rigidly secured to the bar 96. Above each tube 97 a rotatable handle 98 is provided. By rotating the handle 98 the wheel 94 may be moved up or down relative to the tube 97. Since the tube 97 is immovably fixed to the horizontal bar 96 of the framework 6, such up or down movement of the wheel can lower or raise, respectively, the framework 6 relative to the ground. The wheel unit 95 is itself of a known type.

As will be seen from FIGS. 8 and 9, the framework 6 comprises a plurality of mutually perpendicular members. As seen in FIG. 9, a stiffening member 101 extends between respective portions of two mutually perpendicular members 103 and 105. In this embodiment a plurality of such stiffening members 101 are provided. The stiffening members served to stiffen the framework. This is particularly useful because the frame work is free standing and is not supported by an adjacent structure. The stiffening members 101 help to stabilise the training apparatus both when it is being used for training and when it is being moved on its wheels.

Further details of the mounting of the stiffening member are shown in FIGS. 10 and 11. The stiffening member 101 is in the form of a flat elongate plate which extends diagonally between respective end plates 102 and 104, which are also elongate plates. The plate 101 is arranged in a generally horizontal plane, whilst the end plates 102 and 104 are each arranged in a generally vertical plane. End plates 102 and 104 are mutually perpendicular. The stiffening plate 101 is welded at each end to the respective end plates 102 and 104 to create a bracket 106. Each bracket 106 is welded at a corner between two mutually perpendicular members of the framework 6. The end plates of the bracket are bolted to these mutually perpendicular members.

In this embodiment, the bracket is used between a pair of mutually perpendicular members which are arranged in a generally horizontal plane, but in alternative embodiments, the bracket could be used between a horizontal member and an upright member, i.e. mutually perpendicular members which are in a generally vertical plane. Some embodiments may include a bracket in a generally horizontal plane and another bracket in a generally vertical plane.

In this embodiment a plurality of brackets is advantageously provided.

In the third embodiment shown in FIGS. 12 and 13, training apparatus 1 comprises exercise equipment 5 which consists of a framework 6. The exercise equipment comprises various components, including climbing ropes, a climbing rope tower, a climbing net, a pull-up bar and a climbing wall.

The training apparatus comprises first and second breaching doors 17. Each breaching door is provided in a door frame 71 which is itself supported by an outer frame 79, as in the second embodiment.

In the training apparatus of the third embodiment, a plurality of lateral mounting plates 110 is provided. Each plate extends in a generally vertical plane, and collectively the plurality of the plates all extend in the same vertical plane. In use, the plates are used to bolt or otherwise secure the training apparatus 1 to a wall of a structure. This may be a structure as shown and described in relation to the first embodiment, i.e. a transportable structure, or it may be a non-transportable structure such as a building.

It will therefore be seen that in all the embodiments there is provided a training apparatus comprising exercise equipment and a breaching door, in line with the broad aspect of the invention mentioned above. This allows personnel to practice breaching whilst being physically tired, after having used the exercise equipment. The breaching door may be provided as part of a partition of a structure, as in the first embodiment, or it may be mounted in a door frame of a framework which is part of the exercise equipment, as in the second and third embodiments.

1. A training apparatus comprising a structure and exercise equipment, wherein
the structure includes a first side wall, a second side wall and a partition;
the partition extends between the first side wall and the second side wall and comprises a breaching door; and
the exercise equipment is mounted to an external surface of the structure.

2. A training apparatus as claimed in claim 1, wherein the structure is positionable on a ground surface and at least some of the exercise equipment is configured to be engageable with the ground surface.

3. A training apparatus as claimed in claim 1 or 2, wherein at least some of the exercise equipment is fixed to the first side wall and/or the second side wall.

4. A training apparatus as claimed in claim 1, 2 or 3, wherein at least some of the exercise equipment is located adjacent to the external surface of the first side wall and at least some of the exercise equipment is located adjacent to the external surface of the second side wall.

5. A training apparatus as claimed in any preceding claim, wherein the structure is an ISO shipping container.

6. A training apparatus as claimed in any preceding claim, wherein the first side wall and/or the second side wall comprise a reinforced portion and/or a wooden portion.

7. A training apparatus as claimed in claim 6, wherein the reinforced portion is a ballistic wall.

8. A training apparatus as claimed in any preceding claim, wherein at least one of the first side wall and the second side wall comprises at least one breaching window.

9. A training apparatus as claimed in claim 8, when dependent on claim 6 or 7, wherein the breaching window is provided in the reinforced portion and/or wooden portion.

10. A training apparatus as claimed in any preceding claim, wherein at least one of the first side wall and the second wall comprises at least one aperture.

11. A training apparatus as claimed in claim 10, when dependent on claim 6 or 7, wherein the aperture is provided in the reinforced portion and/or wooden portion.

12. A training apparatus as claimed in any preceding claim, wherein the structure comprises a roof extending between the first side wall and the second side wall and the partition extends to the roof.

13. A training apparatus as claimed in claim 12, wherein at least some of the exercise equipment is located at a height above the roof.

14. A training apparatus as claimed in claim 12 or 13, wherein at least some of the exercise equipment is fixed to the roof.

15. A training apparatus as claimed in claim 12, 13 or 14, wherein the roof is strengthened such that it is capable of supporting the weight of one or more adult person(s) training thereon.

16. A training apparatus as claimed in any of claims 12 to 15, wherein the roof comprises a roof hatch.

17. A training apparatus as claimed in any preceding claim, wherein the structure comprises a floor extending between the first side wall and the second wall and the partition extends to the floor.

18. A training apparatus as claimed in claim 17, wherein the floor comprises a floor hatch.

19. A training apparatus as claimed in any preceding claim, wherein the partition is a first partition and the breaching door is a first breaching door, and the structure further comprises a second partition, the second partition extending between the first side wall and the second side wall and comprising a second breaching door.

20. A training apparatus as claimed in claim 19, when dependent on claim 6, 7, 8, 9, 10, 11, 16 and/or 18, wherein the reinforced portion, the breaching window, the aperture, the roof hatch and/or the floor hatch are located between the first partition and the second partition.

21. A training apparatus as claimed in any preceding claim, wherein the structure comprises an internal cage for providing structural support to the structure.

22. A training apparatus comprising the training apparatus as claimed in any preceding claim and a second structure, wherein:
the second structure includes a first side wall, a second side wall and a partition, the partition extending between the first side wall and the second side wall and comprising a breaching door; and
the second structure is located on top of and is fixed to the training apparatus of any preceding claim.

23. A training apparatus comprising the training apparatus as claimed in any of claims 1 to 21 and a second structure, wherein:
the second structure includes a first side wall, a second side wall and a partition, the partition extending between the first side wall and the second side wall and comprising a breaching door; and
the training apparatus of any preceding claim is located on top of and is fixed to the second structure.

24. A training apparatus comprising exercise equipment, the exercise equipment comprising a framework, and the training apparatus comprising a breaching door mounted in a door frame of the framework.

25. A training apparatus as claimed in claim 24, wherein the framework comprises an outer frame having at least two upright members each extending vertically in the same general plane as the door frame with at least one upright member on each side of the door frame, and a cross member extending between the upright members above the breaching door.

26. A training apparatus as claimed in claim 25, wherein the door frame has a pair of upright jambs and each jamb is rigidly secured to a respective upright member of the outer frame.

27. A training apparatus as claimed in claim 24, 25 or 26, comprising a set of rolling members attached to the framework.

28. A training apparatus as claimed in claim 27, wherein the vertical position of each rolling member is adjustable relative to the framework so as to be movable between a lower position allowing the rolling members to roll along the ground when the frame is to be moved, and a raised position allowing feet of the framework to engage the ground.

29. A training apparatus as claimed in any of claims 24 to 28, wherein the framework comprises at least two mutually perpendicular members, and a stiffening member extending between respective portions of the at least two mutually perpendicular members at a non-perpendicular angle to both the members.

30. A training apparatus comprising exercise equipment, the exercise equipment comprising a framework, and the framework comprising feet for engaging the ground, at least two mutually perpendicular members, a stiffening member extending between respective portions of the at least two mutually perpendicular members at a non-perpendicular angle to both the members, and a set of rolling members attached to the framework, the vertical position of each rolling member being adjustable relative to the framework so as to be movable between a lower position allowing the rolling members to roll along the ground when the framework is to be moved, and a raised position allowing the feet of the framework to engage the ground.

31. A training apparatus as claimed in claim 30, wherein the at least two mutually perpendicular members and the stiffening member are arranged in a generally horizontal plane.

32. A training apparatus as claimed in any of claims 24 to 31, comprising a plurality of plates all arranged in the same general vertical plane, for mounting the apparatus to a structure.

33. A training apparatus as claimed in any preceding claim, wherein the exercise equipment comprises functional training equipment.
